(19) United States
(12) Patent Application Publication
(10) Pub. No.: US 2006/0105191 A1
(43) Pub. Date: May 18, 2006

(54) Composite material slide layer and process for manufacture thereof

(76) Inventors: Karl Holdik, Ulm (DE); Florian Lampmann, Ulm (DE); Oliver Methner, Neu-Ulm (DE); Torsten Wittrowski, Ulm (DE); Ansgar Zoller, Neu-Ulm (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 11/280,149

(22) Filed: Nov. 16, 2005

(30) Foreign Application Priority Data
Nov. 16, 2004 (DE) 10 2004 055 199.5

(51) Int. Cl. B32B 15/04; B22F 3/26

(52) U.S. Cl. 428/545; 427/446

(57) ABSTRACT

Slide layers, in bearing shells or exhaust gas turbo chargers of internal combustion engines, formed by a metal matrix with embedded polymer or embedded polymer and ceramic, as well as methods for production for this type of slide layers by means of a thermal spray process, in particular arc wire spray processes (LDS) wherein the substantial proportion of the metallic spray material is introduced prior to the spray nozzle, and the polymer spray material in powder or wire form is introduced into the spray stream subsequent to the spray nozzle using a supply device.

### BACKGROUND OF THE INVENTION

1. Field of the Invention

The invention concerns processes for coating substrates, in particular bearing shells or exhaust gas turbochargers, by means of a thermal spray process, in particular an arc wire spray process (LDS), with a composite layer of metal/polymer or metal/ceramic/polymer, as well as slide layers on a metallic substrate of a composite material.

2. Related Art of the Invention

DE 100 35 032 A1 discloses a process for production of a piston rod with a bearing layer, wherein the bearing layer is applied preferably by means of a thermal spray processes, in particular plasma spraying or arc wire spraying, and preferably is comprised of Al/Cu-alloys or Cu/(Zn, Al, Sn)-alloys.

DE 100 35 031 A1 discloses slide bearing layers likewise obtained by thermal spraying. Therein the slide bearing layers exhibit a gradual change in the composition of the coating with increasing layer thickness. The coating is preferably comprised mainly of Cu/Al-alloys near to the substrate and exhibits an increasing component of titanium oxide further from the substrate.

The thermally deposited layers exhibit various degrees of roughness or porosity at their surface, which as a rule necessitates a follow-up flattening or polishing treatment. A further characteristic of the depositing process is that the thickness of the layers, in particular in the case of geometrically complex substrates, cannot be precisely adjusted. Thus, the layers must, as a rule, be further processed with regard to the final mass.

If very tightly packed slide gaps are required, or complex surface contours which must be oriented precisely relative to each other, then the required fine working of the slide bearing outer layers is frequently achievable only with difficulty, if at all.

### SUMMARY OF THE INVENTION

It is the task of the invention to provide a slide layer which can be made to precisely complement a friction or slide partner, without requiring a precision fitting surface treatment to achieve a particular final dimension, as well as an economical process for the formation of this type of layer.

The task is inventively solved by a process for coating substrates, in particular bearing shells, as well as a thermal spray process, in particular an arc wire spray process (LDS), with a metallic or metallic/ceramic composite layer with polymers, as well as a slide layer on a metallic substrate, comprising a composite material.

In a first aspect of the invention a thermal spray process is provided which makes it possible to deposit composite materials upon a substrate. Therein, the substrate material is preferably a metal. The composite material is comprised of a metallic matrix or a metal/ceramic composite material, in which polymer material is embedded.

The process for production of this composite layer envisions in accordance with the invention the joint deposition of the individual components of the composite layer in a thermal spray process, wherein the metallic spray material is introduced essentially ahead of the spray nozzle and is melted, and the polymer spray material is only introduced into the spray stream after the spray nozzle. Thereby it is essential, that the polymer spray material with its supply apparatus is introduced into the spray stream only after the spray nozzle, wherein the polymer spray material is introduced in powder or wire form. The term wire is intended to include thick polymer filaments as well as rods, as well as threads or cables of individual filaments.

The metallic spray material is particularly preferred to be comprised of slide bearing metals or alloys. These include in particular Cu-alloys and Cu- or Al-bronzes, as well as brass.

Herein it is however not excluded, that subsequent to the spray nozzle, in addition to the polymer spray material, also further components, in particular metallic or ceramic spray material, are introduced into the spray stream. The substantial portion of the metallic spray material is however introduced prior to the spray nozzle.

Among the suitable thermal spray processes, there may be mentioned the most conventional spray processes, such as flame spraying, high speed flame spraying, plasma spraying, and in particular, arc wire spraying (LDS), as well as the LDS-hybrid processes. The LDS-hybrid processes differ from the well known LDS processes thereby, that the spray device or, as the case may be, the spray pistol is supplied with an oxygen containing atomizing gas and a combustion gas. The combustion gas is ignited in a combustion chamber between the wires in the immediate vicinity of or subsequent to the arc wire. Thereby, in the spray stream, an elevated energy is introduced and the spray particles achieve a higher impulse, whereby comparatively dense and solid layers can be deposited.

The introduction of the polymer subsequent to the spray nozzle has substantial advantages with respect to the types of processes in which the material is introduced in the combustion chamber prior to the spray nozzle.

By the inventive process it is ensured on the one hand that the polymeric spray material exhibits a short as possible dwell time in the hot zone of the spray device. By feeding into the spray stream, the polymeric materials are subjected to a comparatively lower thermal stress. Thereby, the decomposition or pyrolysis of the polymers is substantially suppressed or even completely avoided.

It is a further advantage that the proportion of the polymer material can be varied in a very simple manner, without having to adapt the process parameters in the combustion chamber itself. In particular, the conditions in the combustion chamber, or as the case may be prior to the spray nozzle, are substantially independent of the amount of the material supplied downstream of the spray nozzle.

Likewise, in simple manner, the polymer material can be varied during the depositing, or other additives can even be substituted, without having to undertake significant changes in the parameters of the spray apparatus.

A further advantage is comprised therein, that no high demands are placed upon the type or morphology of the polymeric spray material. Thus, for example, for carrying out of the LDS process, no plastic, or as the case may be, metal/plastic composite wires, are needed. Rather, the polymer can be supplied in power form or as a wire.

Depending upon the availability, the polymer can be introduced in wire or in powder form.

Basically, it is possible to provide the polymer material as carrier for further materials. In an inventive embodiment, mixtures of polymer/polymer, polymer/metal, or polymer/ceramic are supplied in powder or wire form into the spray stream. Therein, the polymer as carrier forms a matrix for the further materials. This embodiment has the advantage that very different mixtures can be produced in simple manner and homogenously introduced into the spray stream.

A further useful variant of the polymer/ceramic mixture comprises polymer coated ceramic particles. These can be obtained, for example, by spray drying, or spray granulation processes.

Likewise, it is however also possible to supply the further materials separately from the polymer, for example, in a mixture of various types of powders or in a separate supply device. In the latter case, multiple supply devices with various materials are necessary.

In a further advantageous embodiment of the invention, polymeric material is employed in the form of a composite wire of metal and polymer, wherein the cover is comprised of metallic spray material, and the core of a polymer. This embodiment has the advantage that even a polymer in the form of a powder is easily introduced, since it is held by the metallic cover. Further, it could accomplished thereby, that the polymer is substantially in the form of a metal coated droplet. The deposited composite material is thereby built up comparatively homogenously. Likewise, this embodiment leads to a low thermal load of the polymer material during the depositing process.

In a further advantageous embodiment of the invention, the polymers are in the form of wires of polymer mixtures or polymer blends. Thus, the wire can, for example, be built up of cables or threads of different polymers.

As polymers, various aliphatic or aromatic polymers are suitable. Preferred are however polymers which have a high melting point, or cannot be melted.

One of the most important functions of the polymers in the deposited composite material is to impart a high slideability in relative to a rubbed-against partner, and to assure an enduring deformability or reformability of the surface with low forces. Therein, the melting of the polymer in response to application of force or in response to friction loading of the surface is rather disadvantageous, since upon cooling, this could lead to a sticking to the partner being rubbed against.

It is particularly advantageous when the surface of the deposited layer is conformed precisely by the contour of the rubbing partner by wearing down and/or by material removal and/or deformation. Accordingly, in particular, high melting thermal plastics or non-melting resins or polymers are preferred as polymer material.

The non-melting resin or polymer is therein preferably finely pulverized, preferably embedded in a carrier of thermal plastic polymer or in a metal encasing wire, for introduction into the spray stream, since an atomization cannot occur with the finest liquid droplets.

The preferred polymers include fluoridated polyaliphatics, in particular polyvinylidene fluoride (PVDF) and/or polytetrafluoroethylene (PTFE), polyether, in particular, polyoxymethylene, or polyolefin, in particular polyethyleneoxide, polyethylene, polypropylene, or polyaromatics, such as polyphenylene and/or phenolresins. Fibrous polymers, which can be shaped into, for example, threads or cables, include in particular polyester or polyamide.

A further embodiment envisions that the polymer wires or powders include ceramic components, such as resins and/or dry lubricants. By the employment of polymer bound ceramic particles, or as the case may be, ceramic powder/polymer mixtures in powder or wire form, it is possible in simple manner, to introduce ceramic particles into the spray process which could otherwise be introduced only with difficulty.

It is likewise however also possible that the ceramic spray material is exclusively or supplementally supplied into the combustion chamber, or as the case may be, the arc wire ahead of the spray nozzle, in the form of a wire with metal coating and with a core of the ceramic.

Particularly advantageous coatings exhibit a good flattenability or deformability as determined by the polymer and/or ceramic content in the proximity to its outer surface. Deep down, or as the case may be, at the base of the layer, this material characteristic is rather not desired. Moreover, deep down a highly friction resistant layer with good adhesive properties to the straight material is necessary. Accordingly, in this further embodiment of the invention, it is envisioned that the proportion of the polymer in the spray stream is changed during the coating. Thereby, with regard to the concentration of the polymer, gradient layers are built up. The adjustment of the gradient can in analogous manner also be carried out for the supplied ceramic material. It is particularly preferred when the proportion of the polymer is increased during the coating, so that the proportion of the polymer in the layer exhibits a gradient increasing from the base to the outer surface.

In the ceramic materials, which are deposited in the layer, these could be slide materials or dry lubricants and/or hard.

The dry lubricants support the action of the polymer during the adaptation of a flat surface of the deposited layer to the rubbing partner. Beyond this, these lead to a long lasting lubricant effect in sliding contact with a rubbing partner. As dry lubricant, or as the case may be, slide material, it is particularly preferred to employ boronitride, molybdenumsulfide, antimonysulfide or graphite individually or as a mixture.

The hard material of ceramic supports the friction resistance of the layer. In the sliding operation, this is, by wearing away or frictional removal of the layer, this is pushed back to the desired depth. Suitable hard materials are in particular metal/boride, such as for example B₄C or titanium boride, metal-carbide, such as for example TiC or SiC, metal-silicides, such as for example TiSi or chrome silicides, or metal-nitride, such as for example Si₃N₄ or TiN, or metaloxides, such as for example Al₂O₃, or ZrO₂.

If dry lubricants or hard materials are simultaneously deposited, then the relationship is preferably so adjusted, that the amount of the hard material predominates during the depositing period.

After the thermal depositing of the layer, the follow-up processing or finish processing of the surface can occur depending upon the layer quality and the geometric requirements.

Further, it could be advantageous to carry out a pre-treatment of the metallic substrate, in particular by roughening of the surface or application of adhesive material layers.

A further aspect of the invention concerns slide layers upon metallic substrates, which are formed of metal/polymer, metal/ceramic/polymer composite materials.

These composite materials exhibit as primary component a metal matrix, in which ceramic or, as the case may be, the polymer, is embedded.

The inventive slide layer is perfectly employed where a precise conformity relative to the rubbing partner, or as the case may be, sliding partner occurs only during a breaking-in phase. The precisely complimentary surface is therein achieved in a breaking-in phase by rubbing away of the surface and shaping of the surface by the sliding or friction partner. The inventive slide layer thus also exhibits the function of a breaking-in layer.

The slide layers preferably are employed as bearing layers in automotive manufacture. A further advantageous use is as a coating in turbochargers, in particular the rotor blades.

In accordance with the invention, the metal matrix is comprised of a bearing metal or a bearing metal alloy. The preferred alloys include Cu-alloys, in particular, bronze or brass. Among others, Al-bronzes also are suitable.

The slide layer is comprissed preferably of more than 80 wt. % of the metallic material of the matrix material. The metal component can exhibit a gradient of its concentration across the layer. In a preferred variant, the side of the layer nearest the substrate exhibits a higher metal content than the surface. Preferably preferred is when the side closest to the substrate is comprised substantially only of metal, in certain cases with ceramic as a further component.

The inventive slide layer exhibits the conventional thicknesses of the slide layers and breaking-in layers. They typically are in the range of a few micrometers up to one to two mm.

In accordance with the invention, it is provided that the slide layers exhibit 0.5 to 15 wt. % polymers.

Therein, the distribution of the polymers can vary in the layer. In accordance with the invention, at least the surface, and/or in a material layer near to the surface, polymers are present in a proportion of greater than 0.5 wt. %. The thickness of this near-surface layer is however, depending upon the total layer thickness, typically a few micrometers to several 100 μm and includes not less than 5% of the thickness of the total slide layer.

In a further variant of the inventive slide layer, besides the polymer materials, also ceramic materials are embedded in the metal matrix. In accordance with the invention, it is envisioned that the slide layer includes 0.5 to 15 wt. % ceramic. The ceramic content can likewise exhibit a concentration gradient just like the polymer content.

The ceramic material is selected from the group consisting of hard materials or dry lubricants.

1. A process for coating substrates, in particular bearing layers, by means of a thermal spray process, in particular the arc wire spray process (LDS), with a composite layer of metal/polymer, or metal/ceramic/polymer, comprising:
introducing the principal proportion of the metallic spraying material ahead of the spray nozzle, and
introducing the polymer spray material in powder or wire form with a supply device into the spray stream after the spray nozzle.

2. The process according to claim 1, wherein the polymer spray material is supplied in the form of a wire with a cover of metallic spray material and a core of polymer.

3. The process according to claim 1, wherein the ceramic is supplied into the spray stream in the form of a wire with a cover of metallic spray material and with a core of ceramic.

4. The process according to claim 3, wherein the ceramic spray material is supplied into the arc in the form of a wire with a metal cover and with a core of ceramic.

5. The process according to claim 1, wherein the polymers and the ceramic spray material are injected into the spray stream in particle form.

6. The process according to claim 1, wherein the ceramic and the polymer spray material are selected from polymer coated ceramic particles or polymer/ceramic-composite particles.

7. The process according to claim 1, wherein the proportion of the polymer in the spray stream is varied during coating.

8. The process according to claim 7, wherein the proportion of the polymer is increased during the coating.

9. The process according to claim 1, wherein the polymers were selected from the group consisting of polyaliphatics and/or polyaromatics.

10. The process according to claim 8, wherein the polymers were selected from the group consisting of fluoridated polyaliphatics, in particular polyvinylidenefluoride (PVDF) and/or polytetrafluoroethylene (PTFE), or the polyethers, in particular polyoxymethylene, or polyethylenoxide, or phenol resins, and/or polyolefines, in particular polyethylene or polypropylene.

11. The process according to claim 1, wherein the metal is selected from Cu-bronzes with 4 to 8% Sn and 0.5 to 2% Ag or a bronze with 1.5 to 6% Zn and 0.5 to 2% Si.

12. The process according to claim 1, wherein the ceramic is selected from hard materials comprising metal-boride, -carbide, -silicide, -nitrate, or -oxide.

13. The process according to claim 1, wherein the ceramic is selected from dry lubricants, in particular boronitride, molybdenumsulfide, antimonysulfide or graphite.

14. The process according to claim 12, wherein the ceramic is selected from hard materials and dry lubricants, wherein the amount of the hard material predominates.

15. A slide layer on a metallic substrate, which is formed of a composite material, wherein the composite material is formed by a metal matrix with embedded polymer or embedded polymer and ceramic.

16. The slide layer according to claim 15, wherein the metal matrix is formed of a bearing metal on the basis of a Cu-alloy.

17. The slide layer according to claim 15, wherein the deposited layer comprises 0.5 to 15 wt. % ceramic in the form of hard material or dry lubricant.

18. The slide layer according to claim 15, wherein the deposited layer includes 0.5 to 15 wt. % polymers.

19. The slide layer according to claim 15, wherein the metal matrix constitutes greater than 80 wt. % of the composite material.

20. The slide layer according to claim 15, wherein the proportion of the polymer and/or the ceramic dry lubricant increases within the slide layer from substrate towards surface.

21. The slide layer according to claim 20, wherein the layer near to the substrate of the slide layer is substantially free of polymers or ceramic dry lubricants.

22. (canceled)

23. A turbocharger for an internal combustion engine, wherein the rotor or a friction layer exhibits a slide layer on a metallic substrate, which slide layer is formed of a composite material is formed by a metal matrix with embedded polymer or embedded polymer and ceramic.
